(19) United States
(12) Patent Application Publication
(10) Pub. No.: US 2011/0185416 A1
(43) Pub. Date: Jul. 28, 2011

(54) METHOD AND APPARATUS FOR AUTHENTICATING A PERSON BY THEIR TYPING PATTERN USING THE LOCAL DISTRIBUTION OF KEYS ON A KEYBOARD

(76) Inventors: Thomas Wölfl, Regensburg (DE); Thomas Grundner, Regensburg (DE)

(21) Appl. No.: 12/999,667

(22) PCT Filed: Jun. 19, 2009
(86) PCT No.: PCT/DE09/75028

§ 371 Date: Mar. 31, 2011

(30) Foreign Application Priority Data
Jun. 19, 2008 (DE) 102008002544.5

(51) Int. Cl. G06F 21/00

(52) U.S. Cl. 726/16

(57) ABSTRACT

The present invention relates to a method and an apparatus for authenticating a person by means of their typing pattern, wherein, evaluation of key actuation takes account of the local position of the actuated keys (14).

### BACKGROUND OF THE INVENTION

1. Field of the Invention

The present invention relates to a method and an apparatus for authenticating a person, in which a keyboard with several keys is provided, on which the person to be authenticated makes an input, in which several keys are pressed, so that the person can be authenticated from the characteristics of key actuation.

2. Prior Art

Methods and apparatuses for authenticating persons are known from the prior art that utilize the typing pattern on a keyboard of the person to be authenticated. Examples are given in WO 98/06020 A2 and U.S. Pat. No. 6,151,593 A.

Although these authentication methods and apparatuses do produce very good results, there is an ongoing need to enhance the security and reliability of such methods and apparatuses and to improve convenience by entering short character strings. These objectives, which are actually incompatible with each other because a high level of security usually requires a long character string, make it necessary to continually think about improvements to these processes.

### DISCLOSURE OF THE INVENTION

### Object of the Invention

It is therefore an object of the present invention to provide a method and an apparatus for authenticating a person from their typing pattern, which, especially through the use of short character strings, are better than the prior art at meeting the opposing goals of high security and reliability and convenience.

### Technical Solution

An aspect of the present invention proceeds from the recognition that the scope for authentication can be improved and the security and reliability of authentication thereby increased by including the local position of the keys to be actuated in the analysis. This allows other characteristics of the user's typing pattern, which are necessitated by the local distribution of the keys on a keyboard, to be rendered useful for authentication or to rule out influences when different keyboards are used.

An aspect of the invention can be used in combination with all known methods and apparatuses for authenticating a user from their typing pattern, wherein the known methods and apparatuses usually feature devices that, when the keyboard is actuated, log the keystroke data containing the information via the actuated keys and/or the timing of actuation and/or the duration and the type of actuation. The type of actuation on one hand can be information as to whether a key is being pressed or released and/or the pressure which is being applied to the key or to a touch-sensitive typing field and the like.

In order that the local position of the actuated keys may be incorporated into the evaluation, in a method of the present invention, information can be provided about the distance between keys, the distance between groups of keys, for example, of key areas such as the number pad on a PC keyboard, the directional distance between keys or groups of keys, e.g., along coordinate axes and the coordinates of keys in a coordinate system. Further information about the local position or distribution of the keys can comprise information about arrangement along certain lines, columns, rows, arrangement in certain fields, and in turn the position within the rows, columns or fields and/or neighborhood information about a particular key. Overall, all kinds of information about the local position of the actuated keys is provided and used.

In the evaluation of key actuation, the keystroke data can be used to ascertain all kinds of characteristic features, such as the holding duration of a key, the transition duration between releasing one key and pressing the next, the transition duration between releasing one key and releasing the next, the transition duration between pressing one key and pressing the next, etc. It is also possible to use the error rate or frequency, as indicated for example by use of the delete key, or the typing speed, which indicates how many words are being written in a certain time, with the typing speed being determined for example from the number of typed spaces. Moreover, the keystroke frequency, i.e., the number of keystrokes per unit time, and other information regarding the frequency of use of certain function keys, the choice of specific keys provided several times on the keyboard, such as the use of the left or right shift key, can also be used. Particular use can be made of special peculiarities, such as temporal or key-related values that fall out of the ordinary. For example, even overlaps, that is, pressing the next key before the previous key is released, can be used as a characteristic feature of the typing pattern of a person, wherein these overlaps can also occur several times, i.e., with several keys in succession.

The local position of the actuated keys can be taken into account by expressing the local position of the keys, i.e., corresponding coordinates or distance values and the like, in relation to determined keystroke data and/or characteristics and thereby generating location-based characteristics.

Thus, the ratio of the distance between consecutive keys and a transition duration can be used to generate a transition speed as a location-related characteristic. In the case of direction-related distance values, this can lead to directional speeds as location-related characteristics.

Overall, distance values and time characteristics can be used to determine speed characteristics as location-related characteristics that can contribute to improved authentication.

The characteristics of several keystrokes, i.e., both the location-related characteristics and the non-location-related characteristics, can be further processed, more precisely, for example, to functional data characteristics, which, for example, represent averages or cumulative totals, and the like for certain determined data. Thus, an average value acting as a functional data characteristic can be calculated for the holding duration of the keys for all keys. In addition, it is also possible to group characteristics into characteristic fields or vectors, wherein either similar or identical characteristics can be grouped together for various keystrokes, such as the holding durations for all keystrokes determined during input or different characteristics of the same keystroke, such as holding duration, transition duration, transition speeds, etc. In this regard, corresponding data characteristics, such as average holding durations, can be incorporated into the characteristic fields or vectors. Overall, keystroke data and characteristics can be processed in diverse ways.

The inventive method makes it possible to authenticate persons using different keyboards, so that persons who want to log onto a certain system using different computer systems around the world and who need to be authenticated, can use different keyboards of the kind in use around the world, since the inventive method takes account of the different arrangements of the respective keys.

Such an apparatus can have in addition to a keyboard for entering a corresponding character string a means of logging keystroke data and a storage unit for storing reference data and a comparison unit for comparing the reference data with data from the character string of the access request, wherein the apparatus can have information about the local distribution of keys on the keyboard or have a facility to obtain access to this information. This can be accomplished, for example, by making it a requirement for the type of keyboard to be entered into the apparatus prior to access control. Alternatively, the apparatus, by means of automated authentication of the connected keyboard, can itself determine such information, wherein, for example, from one central storage location, e.g., via remote data communication, the position data of the keys of a particular type of keyboard can be queried. This is especially easy if an evaluation unit of the apparatus is formed by programmatic design of a data processing unit, as then communication means of the data processing unit, such as network connections and the like, can be used. Similarly, the logging device can be realized additionally to or instead of the sensors assigned to the keyboard, in particular by a data processing program that detects the electrical signals from the keyboard or a typing field upon corresponding actuation.

The authentication apparatus and in particular the evaluation unit and/or the comparison unit can be formed by a programmatically designed data processing unit or integrated into it.

### BRIEF DESCRIPTION OF THE FIGURES

Further advantages, characteristics and features of the present invention are apparent from the following detailed description of embodiments. The drawings show in purely schematic form in a schematic form in

FIG. 1 a schematic illustration of an apparatus with a keyboard for entering the character string for authentication;

FIG. 2 a plan view of a keyboard for use with the present invention;

FIG. 3 a plan view of a further embodiment of a keyboard for use with the present invention;

FIG. 4 a diagram showing the temporal sequence of key actuation as illustrated by the keys for the letters x, y and z.

### PREFERRED EMBODIMENTS

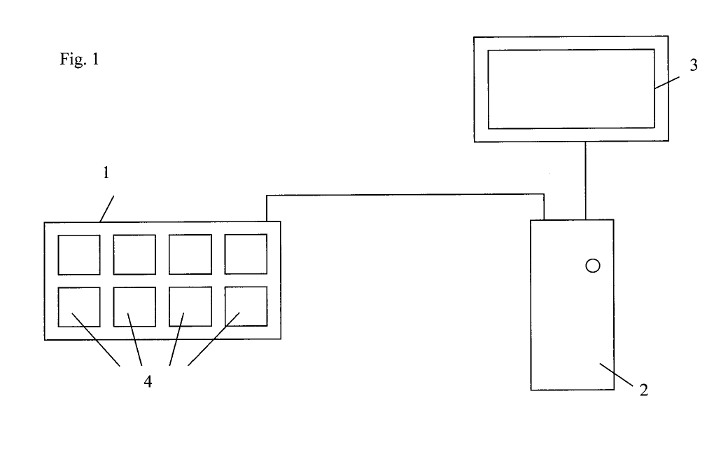

FIG. 1 shows a schematic representation of a keyboard 1, which is operatively connected to a data processing device, such as a personal computer PC 2, wherein a display device 3, such as a monitor or display, can be arranged at the data processing device 2.

The keyboard 1 comprises a plurality of keys or typing fields 4, which can be actuated by pressing with a finger.

The keyboard 1 illustrated in FIG. 1, may be, for example, a restricted keypad, which finds application only for access control to a room or some similar use.

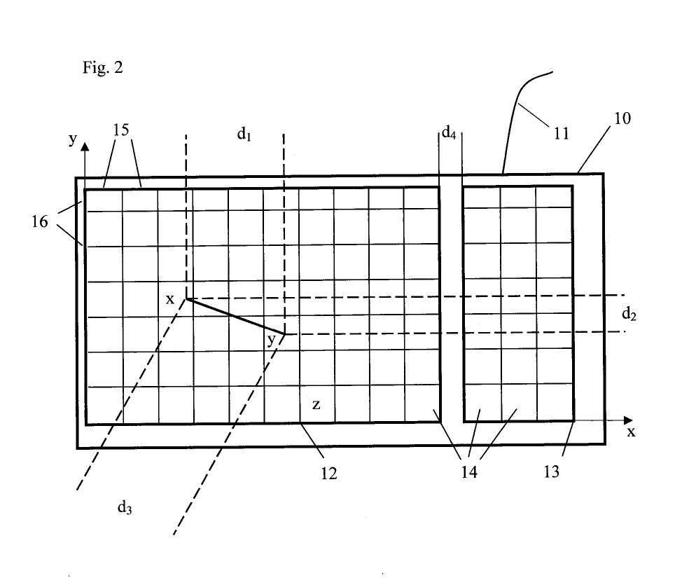

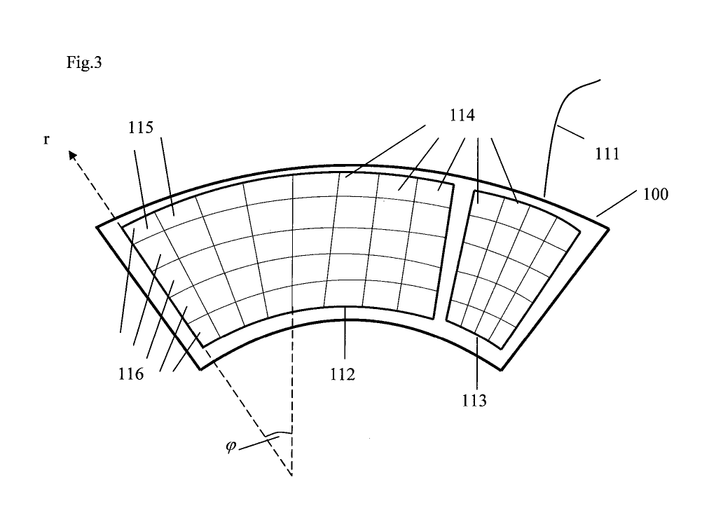

As is clear from the FIGS. 2 and 3 showing further examples of keyboards 10 and 100, the keyboards for use in the case of the present invention can be of various types. FIG. 2, for example, shows a keyboard of the kind usually employed with a personal computer PC. Accordingly, the keyboard 10 has a control and data line 11 for connection to a corresponding data processing device (not shown). The keyboard 10 also has a plurality of keys or typing fields 14 which are arranged in two blocks of keys 12 and 13. For example, in the case of a common PC keyboard, this may be the so-called numeric keypad (keypad 13) and a field with keys that comprise the letters of the alphabet, function keys, etc. (keypad 12).

The keys or typing fields 14 in the keyboard of the embodiment of FIG. 2 are arranged in mutually perpendicular columns 15 and rows 16 such that they extend along the x-y axes of a Cartesian coordinate system. Accordingly, an x-y-coordinate can be assigned to each key or each typing field 14, wherein, on account of the spatial extension of the key or the typing field 14, the center or the focus of a corresponding key 14 can serve as a reference point. Alternatively, the keys or typing fields can be arranged in staggered rows or columns or diagonal rows or columns, or in any arrangement.

For example, if the extension of a key 14 along the x or y coordinate is regarded as one unit of length, the key for the letter x has the x-y coordinates (3, 4), while the key for the letter y has the x-y coordinates (6, 3) and the key 14 for the letter z has the x-y coordinates (7, 1). Unique spatial positions can similarly be assigned to all keys 14 of the keypad 12 and keypad 13.

The spatial positions can also be used to determine relationships of the keys 14 to each other. For example, the distance d₃ between the keys for the letters x and y can be determined from the x-y coordinates. For this purpose, first the distance between the keys for the letters x and y in the x-direction is determined and is denoted by d₁, and then the distance is determined between the keys for the letters x and y in the y-direction and is denoted here by d2. d₁ in the example in FIG. 2 has the value 3, while the distance d₂ in the y-direction has the value 1. The distance d₃ is given by the formula d₃²=d₁²+d₂², so that in this case the value for the distance \sqrt{3²+1²}=\sqrt{10}. Alternatively, a relation between the keys 14 can be determined separately for the x- and y-direction, i.e., distances in the x- and y-direction, or in any other directions.

In addition, it is also possible to determine relations of groups of keys, such as the keypads 12 and 13 of the keyboard in FIG. 2. Thus, the distance d₄ between the keypads can be used. The keypads, or groups of keys can be chosen arbitrarily and are not limited to physically separate keypads, such as the numeric pad and the other keys on the keyboard of FIG. 2. Rather, keys within an arrangement of adjacent keypads or typing fields 14 can also be defined.

As is clear from FIG. 3, any other arbitrarily shaped keyboard can also be used for the invention, wherein in that event, again, the local distribution of the keys can be uniquely identified, for example, again using a Cartesian coordinate system. Instead of a Cartesian coordinate system, though, another coordinates system, such as a polar coordinates system, can be used.

The keyboard 100, which in turn comprises a data and control line 111 to a data processing device not shown in any further detail has, like the embodiment of FIG. 2, a keypad 112 and a keypad 113, which are separated locally by a distance. The keypads 112 and 113 comprise a plurality of keys or typing fields 114, but they are arranged not in straight and perpendicular rows and columns as in FIG. 2, but rather in an angular arrangement of curved columns 115 and rows 116. Accordingly, in line with the radius of curvature, it is expedient to use a polar coordinates system (φ, r) to define the exact spatial distribution of the keys 114. Here, too, the individual positions of the keys can be described exactly and corresponding distances between the individual keys determined, wherein the direct distance between the keys and the directional distance along a particular axis or direction can be determined in a defined manner. In addition, the position of the individual keys can be defined by assigning them to specific rows and columns, and specifying the position in the corresponding row or column by, e.g., position numbers.

Moreover, in the embodiment of FIG. 3, as was shown in FIG. 2, a distance d₄ between the keypads 12 and 13 can be determined and used to evaluate the typing pattern.

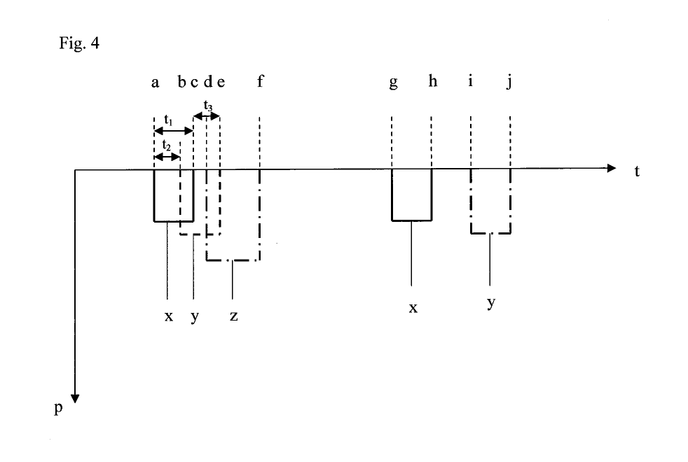

FIG. 4 shows in a flow diagram along a time axis t the sequence of the character string xyzxy in which the corresponding keys for the letters x, y and z are pressed in the corresponding sequence. As is clear from the diagram in FIG. 4, the keys or typing fields 4, 14, 114 are actuated at times a to j. At time a, the key for the letter x is pressed while, at time c, the x key is released again. At time b, the y key is pressed and is released again at time e. The z key is pressed at time d and released at time f, while the x key is pressed at time g and released at time h. Finally, the y key is pressed a second time at time i and released at time j.

The actuation of the keys can now be used to determine characteristics such as the holding duration or the transition duration.

Thus, the holding duration tᵢ for the x key is given by the difference between times a and c. The transition duration t₂ for the press-transition from x to y is given by the difference between the time a when the x key is pressed and the time b when the y key is pressed, while, e.g., the release transition duration t₃ for the key sequence x-y is defined by the release of the x key at time c and the release of the y key at time e.

In addition, the logging device, for example, can determine the pressure p applied by the user to the keys 4, 14, 114. This is also shown in FIG. 4, which indicates purely schematically that a constant pressure exists between pressing and releasing. The pressure can however also follow a certain time-change pattern, which can also serve as a characteristic of the typing pattern. As the chart in FIG. 4 shows, the x key is actuated with less pressure than the y key or z key, with the y key in turn being actuated with less pressure than the z key.

By means of the logging device of an inventive apparatus which can be at least partially implemented, for example, in a data processing unit 2 by a corresponding data processing program in such a way that values determined by sensors on the keyboard are logged, and information about which keys are pressed at which point in time, is determined and stored. This information constitutes the keystroke data. The keystroke data can be used to determine corresponding characteristics, such as transition durations t₂, t₃, or holding durations t₁, which in turn can be further processed for all keystrokes or for specific keys to yield average values (functional data characteristics). Accordingly, many different characteristics, such as transition durations, transition speeds or holding durations, or similar characteristics, such as holding durations for various specific keys can be grouped to characteristic fields or vectors. The data measured in this way, i.e., all keystroke data as well as the derived characteristics, characteristic combinations and characteristic vectors, can be used to authenticate a person who makes a key input, wherein the corresponding data, which are determined in the case of access control, are compared with reference data which have been stored for a specific user. The comparison can be performed in all manner of ways by direct pattern matching or by statistical or other mathematical methods.

In an aspect of the present invention, the position of the actuated keys is also taken into account, so that an improvement in characterization of the typing pattern is possible. This follows from the fact that the typing pattern is influenced by the local arrangement of the different keys, wherein it is clear that, in the case of successive keys, which are close to one another, the transition durations are much shorter than for keys widely spaced apart.

For example, the key sequence in the chart of FIG. 4 shows that, for the key sequence xyz, the subsequent keys are pressed a lot faster, with the result that overlaps occur, i.e., the y key is pressed before the x key is released and the z key is pressed before the y key is released, whereas for the key sequence zx, in which distance between the successive keys is large, does not entail any overlap and the transition duration is correspondingly long.

The use of position-related key information can also serve to determine corresponding speeds, e.g., for the transition duration t₂ for the transition from the x key to the y key by dividing the distance d₃ by the transition duration t₂. Directional-related speeds can also be determined in this way, such as transition speeds in the x-direction or y-direction. For this, the distances d₁ in the x-direction or d₂ in the y-direction must be divided by the corresponding transition duration t₂.

This transition speed can also be referred to as the Manhattan-speed, because the keyboard is compared to the layout of blocks in Manhattan and the change from one key to another can be viewed as a movement from one block in Manhattan to another.

Although the present invention has been described in detail using the attached embodiments, it is obvious to a person skilled in the art that the invention is not restricted to these embodiments, but rather that modifications in the form of different combinations of individual characteristics, as well as the exclusion of possible characteristics, are possible, without departing from the protective scope of the accompanying claims. Overall, any combination of the presented characteristics is claimed for the present invention.

1-16. (canceled)

17. A method for authenticating a person comprising:
providing a keyboard with a plurality of keys;
having a person to be authenticated actuate several keys, so that the person can be authenticated from characteristics of key actuation; and
evaluating the actuation of the several keys to authenticate the person;
wherein evaluating takes account of a local position of the actuated keys.

18. The method in accordance with claim 17, further including:
providing a logging device, which, when the keys are actuated, logs keystroke data containing information via the actuated keys and/or the timing of actuation and/or the duration and/or a type of actuation, wherein the type of actuation comprises pressing and/or releasing the key and/or the pressure exerted on the key.

19. The method in accordance with claim 17, further including:
providing at least one item of information from a group of information for the purpose of evaluating the key actuation;
wherein the group comprises information about a distance between the keys, distances between groups of keys, a directional distance between the keys or groups of keys, coordinates of the keys in a coordinates system, an arrangement along lines or in fields, the arrangement in rows and/or columns and a position therein.

20. The method in accordance with claim 18, wherein:
evaluating comprises determining at least one characteristic feature from a group comprising a holding duration of a key, a transition duration between releasing a first key and pressing a second key, a transition duration between releasing a first key and releasing a second key, a transition duration between pressing a first key and pressing a second key, an error frequency, a typing speed, a keystroke frequency, single or multiple overlaps, a frequency of use of certain function keys, selection of alternative keys, selection of the left or right Shift key, and temporal or key-related peculiarities which emerge from the keystroke data.

21. The method in accordance with claim 17, wherein:
evaluating comprises generating location-related characteristics by expressing a local position of the keys in relation to keystroke data and/or characteristics.

22. The method in accordance with claim 17, wherein:
evaluating comprises generating a transition speed as a location-related characteristic from a distance between successive keys and a transition duration of a succession of keys.

23. The method in accordance with claim 17, wherein:
evaluating comprises determining directional speeds as location-related characteristics from distance values.

24. The method in accordance with claim 17, wherein:
evaluating comprises determining speed characteristics as location-related characteristics by distance values and time characteristics.

25. The method in accordance with claim 17, wherein:
characteristics for several key actuations are grouped to form functional data characteristics comprising average values or cumulative totals or to characteristic fields or vectors.

26. The method in accordance with claim 17, wherein:
several different characteristics of the same key actuation are grouped to characteristic fields or vectors.

27. The method in accordance with claim 17, further including:
authenticating by comparing reference data for the person to be authenticated. with access data for the person to be authenticated which the person to be authenticated has generated during input via the keyboard.

28. The method in accordance with claim 17, wherein:
the input by the person to be authenticated can occur on different keyboards.

29. An apparatus for authenticating a person comprising:
a keyboard with a plurality of keys for inputting a character string;
a logging device for logging keystroke data upon actuation of the keyboard;
a storage unit for storing reference data for one or more users; and
a comparison unit for comparing reference data with data determined during access of a person to be authenticated;
wherein the apparatus comprises information or access to information about a local distribution of the keys on the keyboard.

30. The apparatus in accordance with claim 29, further including:
an evaluating unit for processing the keystroke data into characteristics for characterizing a typing pattern during input;
wherein the evaluation unit and/or the comparison unit are formed in a single data processing unit.

31. The apparatus in accordance with claim 29, wherein:
the information on the local distribution of the keys on a keyboard is present as stored information in the storage unit or retrievable via data communications.

32. An apparatus for authenticating a person comprising:
a keyboard with a plurality of keys for inputting a character string;
a logging device for logging keystroke data upon actuation of the keyboard;
a storage unit for storing reference data for one or more users; and
a comparison unit for comparing reference data with data determined during access of a person to be authenticated;
wherein the apparatus comprises information or access to information about a local distribution of the keys on the keyboard; and
wherein the apparatus performs the method in accordance with claim 17.
